(19) United States
(12) Patent Application Publication
(10) Pub. No.: US 2008/0030505 A1
(43) Pub. Date: Feb. 7, 2008

(54) Device and adapter system for transmission of monochrome image information

(76) Inventor: Bernd Keuenhof, Kleinsendelbach (DE)

Correspondence Address: BRINKS HOFER GILSON & LIONE, P.O. BOX 10395, CHICAGO, IL, 60610, US

(21) Appl. No.: 11/880,704

(22) Filed: Jul. 24, 2007

(30) Foreign Application Priority Data
Aug. 1, 2006 (DE) DE 102006035862.7

(51) Int. Cl. G09G 5/00

(52) U.S. Cl. 345/501; 345/1.1

(57) ABSTRACT

A device for transmission of monochrome image information from at least two imaging devices to at least two display elements via a cable connection is provided. The device includes an interconnection unit; and a splitting unit connected to the interconnection unit via a common multi-channel transmission cable. The at least two imaging devices are connected to at least two inputs of the interconnection unit via at least one connecting cable, and an output of the splitting unit is connected to the at least two display elements via further connecting cables. The interconnection unit combines, at a common output, the image information provided at the at least two inputs on different image channels, and the splitting unit distributes, to at least two outputs of the splitting unit, the image information provided at a common input of the splitter unit via the transmission cable on different image channels.

This application claims the benefit of DE 10 2006 035 862.7 filed Aug. 1, 2006, which is hereby incorporated by reference.

### BACKGROUND

The present embodiments relate to a device for transmitting monochrome image information of at least two imaging devices.

A medical imaging system, such as a cardiograph or an angiograph, generates image information for a number of display elements. The image information is usually available in a monochrome form, for example as grayscale images. The medical imaging system is generally located in a treatment room. During an examination, the raw measurement data is transferred via connecting lines to a processing unit located in a control room or equipment room. The processing unit generates the monochrome image information from the raw measurement data and displays the image information on a number of display elements located in the immediate vicinity of the processing unit in the control room. The geographical separation of medical imaging system and display elements protects an operator located in the control room or the equipment room from exposure to radiation from an x-ray source of the medical imaging system. The processing unit requires a comparatively large amount of space, so that locating the processing unit separate from the medical imaging system creates additional space in the examination room.

This type of medical imaging system may be used by a doctor undertaking treatment with support from the imaging system to perform medical interventions on a person, for example, the introduction of a catheter, for the purposes of diagnosis or therapy. The doctor performing the treatment is required to be present in the treatment room with the person to be treated. To give the doctor permanent control over the progress of the medical intervention, monochrome image information generated by the processing unit is fed back via cables from the processing unit into the treatment room to display elements arranged there. Comparatively large distances often have to be covered by cables. Cables with very low attenuation are used for this purpose, for example, optical fibers, which are very expensive. Each display usually receives its image information over a separate connecting cable. This results in high investment costs. Each connecting cable has to be laid separately.

### SUMMARY

The present embodiments may obviate one or more of the limitations or drawbacks of the related art. For example, one embodiment is a cost-effective and easy-to-install device for transmission of monochrome image information.

In one embodiment, at least two imaging devices are connected to at least two corresponding display elements via a cable connection. The cable connection comprises an interconnection unit. A splitter unit is linked to the interconnection unit over a common multi-channel transmission cable. Each of the imaging systems is connected to an input of the interconnection unit via a connecting cable. Each display element is connected to an output of the splitting unit by a further connecting cable. The interconnection unit combines the image information provided at its inputs by the imaging system at a common output on different image channels. The splitting unit distributes to the outputs the image information provided at a common input via the transmission cable on different image channels.

A single transmission cable may be used to cover a long distance, for example, between the control room and the treatment room. It is only this transmission cable which needs to have a low attenuation and be designed with the appropriate high quality. The connecting cables that connect the imaging systems to one input of the interconnection unit in each case and the connecting cables that connect the display elements to one output of the splitting unit in each case can have a lower attenuation, since they only need to cover the short path between an imaging system and the interconnection unit or between the splitting unit and the display elements, respectively. A single transmission cable is laid over the long distance. A single transmission cable may be routed much more easily through the restricted space available in the cable channel of a swivel arm, for example, when display elements are mounted on the swivel arm. The connecting cables between the imaging systems and the interconnection unit, the connecting cables between the splitting unit and the display elements, and the interconnection unit and the splitting unit are arranged at the location of the imaging system or at the location of the display element where there is good accessibility and sufficient available space.

In one embodiment, the interconnection unit connects one of the imaging channels of each input to one of the imaging channels of the common output. An imaging device usually outputs image information on different image channels. If monochrome image information is involved, then either only one of the image channels is occupied or all imaging channels of the imaging device are provided with identical image information. For connection of only those imaging channels, which carry the display-relevant information, the number of imaging channels running in the transmission cable is reduced. A reduction in the number of imaging channels running in the transmission cable reduces the number of imaging channels running in the transmission cable, so that the thickness of the transmission cable is reduced. This type of transmission cable may be laid relatively easily.

In one embodiment, the interconnection unit is configured for each input, in addition to an image channel, to route a further channel to the common output. Further image information may be transmitted to the display element to display the monochrome image information.

In one embodiment, the connecting cables and/or the transmission cable are embodied as standardized cables, for example, according to the DVI standard.

The DVI standard is an industry standard for the transmission of digital image information and is defined by the Digital Display Working Group, an organization to which many companies operating in the information technology field belong. The DVI standard is published in what are known as White Papers. The White Paper dated 2 Apr. 1999 is a currently valid document.

A cable embodied according to the DVI standard usually comprises three image channels for the transmission of red, green, and blue image information. A clock signal is transmitted over a further channel, which displays the image information at the display element. For the transmission of monochrome image information each image channel of the connecting cable is provided by the imaging device by default with the monochrome image information. The interconnection unit connects to the common output one image channel and as a further channel the channel with the clock signal for each connecting cable.

In one embodiment, the transmission cable is a standardized cable according to the DVI standard. Two image channels and two further channels provided with a clock signal are transmitted by the standardized cable. A clock signal may be transmitted by a cable embodied according to the DVI standard.

In one embodiment, an image channel which, as well as the color information, contains additional information for the image display by the display element, is selected as the image channel to be transmitted. In the case of a connecting cable embodied according to the DVI standard this is the blue color channel. There are no complicated switchover measures to be undertaken either in the interconnection unit or in the splitting unit. The image information to be transmitted is selected in advance so that it is able to be transmitted with minimal switching effort.

The connecting cables and the transmission cable are usefully connectorized cables with plug-in connectors attached to both ends. Cables embodied according to the DVI standard may be obtained cost-effectively as off-the-shelf cables. The connectorization of the cables enables on-site installation effort to be reduced.

In one embodiment, the interconnection unit includes a memory unit for each connecting cable. The memory unit may store information relating to the characteristics of the corresponding display element, for example, its resolution and image frequency. For a correct presentation of image information at the location of the imaging system, information about the display characteristics of the display element is available. The information about the display characteristics of the display element is usually interrogated via the connecting cable linking the imaging system and the display element in the opposite direction to that in which the image information is transmitted. By storing information of this nature in the interconnection unit, the information can be securely retrieved via the connecting cable. A periodic polling of the characteristics of the display element by the imaging device, for example, over the long length of the transmission cable brings with it the risk of delays caused by long signal transmission times and can thus be dispensed with. The monochrome image information generated by the imaging device matches a corresponding display element in each case. The relevant display mode of the display element matches the information stored for the display element in the memory unit of the interconnection unit.

According to the DVI standard, the polling of the DDC (Display Data Channel) is simulated by the memory unit.

The splitting unit provides the monochrome image information present at one of the image channels of the common input at each image channel of an output. Each individual image channel transfers this image information to the connecting cable leading to the display element. Since during output of monochrome image information an imaging device usually occupies each image channel with identical monochrome image information, the occupation of the image channels by the imaging device may be emulated by the splitting unit. The imaging system may obtain precisely the image information, which it would have obtained if it were connected directly to the imaging device. This guarantees a secure and fault-free operation of the display element.

In one embodiment, the transmission cable includes an integrated transmitter and an integrated receiver that transmits the image information over a long distance. This transmitter and this receiver are, for example, integrated into the connectors plugged-in at either end of the transmission cable. The monochrome image information is transmitted to the individual display elements with little loss.

In one embodiment, the transmission cable is a fiber optic cable. A fiber optic cable has a low attenuation, thus providing a loss-free and secure transmission of the monochrome image information.

In one embodiment, the transmission cable is an Ethernet cable. A switchover to the transmission standard of the Ethernet cable may be easily implemented by the interconnection unit. An Ethernet cable is an especially cost-effective cable, which allows secure data transmission over long distances.

The power may be supplied to the interconnection unit and/or the splitting unit via at least one of the connecting cables. Since both an imaging device and a display element usually have a separate power feed, the power supply to interconnection unit or to the splitting unit via a separate AC adapter is superfluous. This saves the cost of the AC adapter. Neither space for accommodating the AC adapter nor an additional power outlet for the AC adapter needs to be provided.

Power may be supplied to the transmitter and/or the receiver of the transmission cable via the interconnection unit or the splitting unit, respectively, for example, via the plug-in connector. The transmitter is connected to the interconnection unit or the receiver is connected to the splitting unit using the plug-in connector. This saves having to provide a separate power supply, in the form of an AC adapter, for example.

In one embodiment, the interconnection unit and/or the splitting unit have one or more status displays to show the unit's operating status. For example, status displays may include LEDs, which indicate that a transmission of image information is currently taking place.

In one embodiment, an adapter system includes an interconnection unit and a splitting unit. The interconnection unit may combine on different channels at a common output the image information provided at inputs. The splitting unit divides up onto outputs the image information provided at a common input on different image channels. This type of adapter system can, for example, be retrofitted for transmission of monochrome image information from at least two imaging devices to at least two display elements.

The inputs, the outputs, the common input, and the common output are embodied for connection of standard cables. An adapter system for existing imaging devices may be easily retrofitted.

### BRIEF DESCRIPTION OF THE DRAWINGS

An exemplary embodiment of the invention is described below in further detail with reference to a drawing. The figures show:

FIG. 1 is a schematic diagram of one embodiment of a device for transmission of monochrome image information from two imaging devices,

FIG. 2 is one embodiment of a device for transmission of monochrome image information according to the DVI standard.

### DETAILED DESCRIPTION

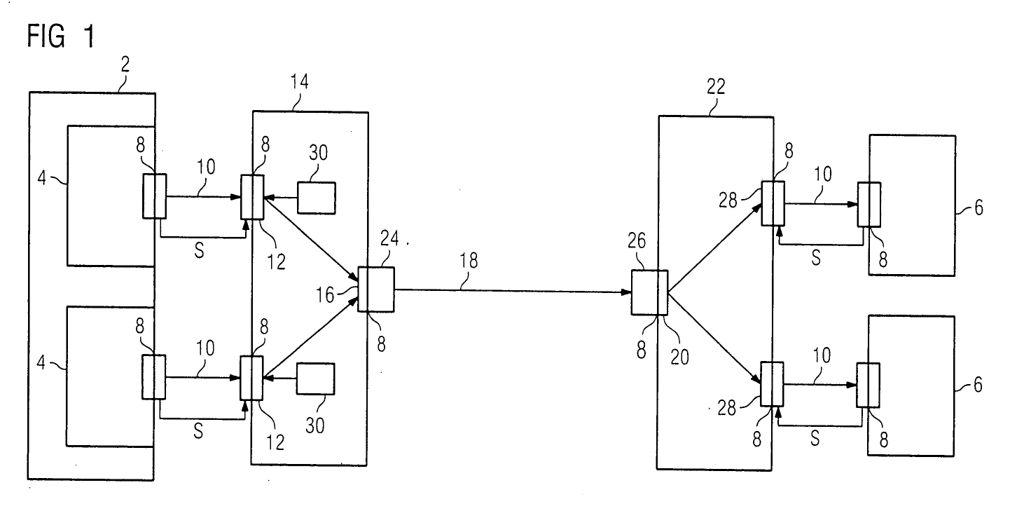

In one embodiment, as shown in FIG. 1, a medical imaging system 2 includes two imaging devices 4 connected to two corresponding display elements 6 via a cable connection.

The medical imaging system 2 may include cardiograph or an angiograph, which generates image information for a number of display elements. The image information may be available in a monochrome form, for example, as grayscale images. The imaging devices 4 may include one or more workstation computers, which generate the image information and output the image information by one or more graphics cards over a cable connection to the corresponding display elements 6.

Each imaging device 4 is connected by a plug-in connection 8 to a connecting cable 10. A further plug-in connection 8 connects the connecting cable 10 to an input 12 of an interconnection unit 14. The interconnection unit 14 combines the image information at the inputs 12 via image channels of the connecting cable 10 at a common output 16 onto different image channels.

Another plug-in connection 8 connects a transmission cable 18 to the output 16. A further plug-in connection 8 connects the transmission cable 18 to a common input 20 of a splitting unit 22. A transmitter 24, which amplifies the monochrome image information for transmission over longer distances, is integrated into the plug-in connection 8 of the transmission cable 18 connected to the interconnection unit 14. A receiver 26 is integrated at the end of the transmission cable 18 connected by a further plug-in connection 8 to the common input 20 of the splitting unit 22. The receiver 26 processes the monochrome image information transmitted by the transmission cable 18 and compensates for possible line losses.

In one embodiment, the transmission cable 18 is an optical fiber. The transmission cable 18 may have a low attenuation in order to keep line losses on the transmission path low.

The splitting unit 22 may distribute the image information provided at the common input 20 via the transmission cable 18 to different image channels on outputs 28. A plug-in connector 8 connects each output 28 to a further connecting cable 10. The further connecting cable 10 leads to one of the imaging systems 6. A plug-in connection 8 connects the further connecting cable 10 to one of the imaging systems 6. The monochrome image information is transmitted via this connecting cable 10 to the imaging system 6 and is displayed there.

In one embodiment, a memory unit 30 is connected to at least one input 12 of the interconnection unit 14. The memory unit 30 may store information about the operating data of the corresponding display element 6, for example, its resolution and image frequency. This information may be retrieved by the imaging device 4 via the connecting cable 10. Communication between the imaging device 4 and the interconnection unit 14 is over just a short length of connecting cable 10. There is no susceptibility to faults, as might arise in communication over the entire length of the cable connection.

In FIG. 1 only two imaging devices 4 are connected to two corresponding display elements 6. The principle of combining monochrome image information on a single transmission cable 18 may, however, also extend to a greater number of imaging devices 4 and/or display elements 6.

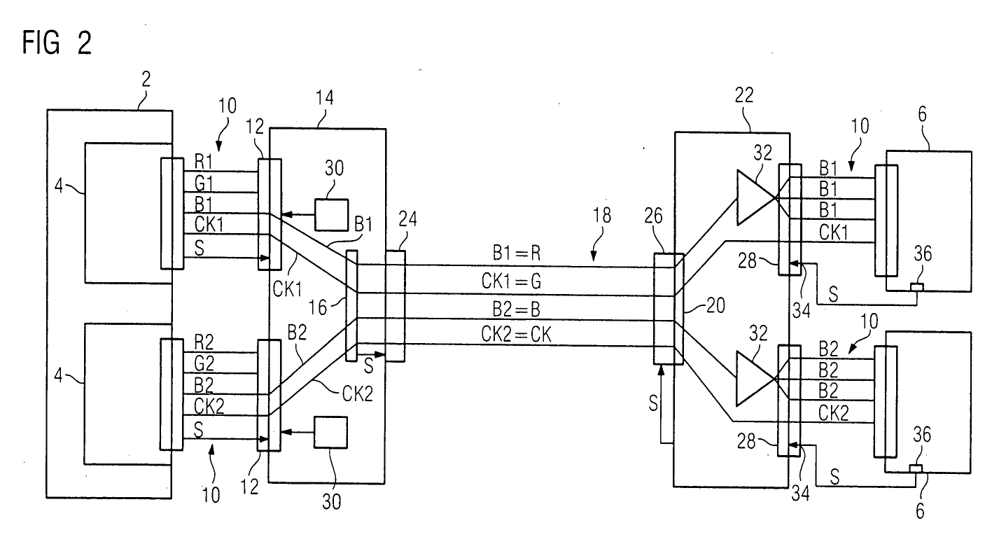

In one embodiment, as shown in FIG. 2, a device for transmission of monochrome image information may include a connecting cable 10 and a transmission cable 18 that are standardized cables according to the DVI standard. In FIG. 2, the arrangement of the individual elements essentially corresponds to the arrangement of the elements in FIG. 1. Each of the two imaging systems 4 is, as described in FIG. 1, connected by a connecting cable 10 to the interconnection unit 14. Each connecting cable 10 features a red color channel R1, R2, a green color channel, G2 and a blue color channel B1, B2. Each connecting cable 10 has a clock channel CK1, CK2, which contains information about the structure of the transmitted image information and about the splitting up of the transmitted image information for display at the display element 6. Two wires may be provided per channel at cable 10, 18 or two pins or jacks for plug-in connection 8.

Each imaging device 4 generates monochrome image information. A display element 6 can display this monochrome image information securely and without faults. The same monochrome image information is transmitted on each of the three color channels of a DVI cable. The data structure that arrives at the display element 6 is used to display the monochrome image information. Individual color channels not being occupied would lead to a fault in the image display.

In one embodiment, the interconnection unit 14 combines the image information provided at the inputs 12 in the form of a number of color channels at the common output 16 in such a way that only the blue color channels B1, B2 are transmitted by the transmission cable 18. All color channels have identical image information, but the blue color channel B1, B2, however, has additional information for the display of the image information at display element 6. The clock signals CK1, CK2 are also transferred to the transmission cable 18.

In one embodiment, the transmission cable 18 is an optical fiber with a low attenuation, which is also embodied according to the DVI standard. The blue color channel B1 is connected to the red color channel R, the clock-channel CK1 is connected to the green color channel G, the blue color channel B2 is connected to the blue color channel B, and the clock channel CK2 is connected to the clock channel CK of the transmission cable 18.

The monochrome image information is transmitted from transmission cable 18 to the common input 20. The splitting unit 22 distributes the image channels B1, B2 and the clock channels CK1, CK2 so that each output 28 is connected to an image channel B1, B2 and to a clock channel CK1, CK2. The monochrome image information B1, B2 is displayed without fault on the individual display elements 6. Each item of image information B1, B2 is switched by a signal multiplier 32 to all three color channels of the output 28 likewise embodied according to the DVI standard. Each output 28 may be connected by a connecting cable 10 embodied according to the DVI standard to a corresponding display element 6. Each of the three color channels of one of the connecting cables 10 transmits the image information B1 or B2 to the corresponding display element 6. In addition the clock signal CK1, CK2 is transmitted via the channel provided for the transmission of a clock signal of the relevant connecting cable 10 to display element 6.

In one embodiment, all connecting cables 10 and the transmission cable 18 include standard DVI cables.

As shown in FIGS. 1 and 2, power is supplied to the interconnection unit 14 over power lines S integrated into the connecting cable 10, which are fed in each case from the imaging devices 4. Power is supplied to the transmitter 24 and the receiver 26 of the transmission cable 18 via the interconnection unit 14 or via the splitting unit 22.

In one embodiment, the splitting unit 22 includes two redundant power supply inputs to which power is supplied in each case via a separate power supply output of a display element 6. If power supply via one of the two power supply inputs fails normal operation of the splitting unit 22 continues to be guaranteed.

Alternatively, the power may be supplied to the interconnection unit 14 and the splitting unit 22 via an external AC adapter.

1. A device for transmission of monochrome image information from at least two imaging devices to at least two display elements via a cable connection, comprising:
an interconnection unit; and
a splitting unit connected to the interconnection unit via a common multi-channel transmission cable;
wherein the at least two imaging devices are connected to at least two inputs of the interconnection unit via at least one connecting cable, and an output of the splitting unit is connected to the at least two display elements via further connecting cables, and
wherein the interconnection unit is operable to combine, at a common output, the image information provided at the at least two inputs on different image channels, and the splitting unit is operable to distribute, to at least two outputs of the splitting unit, the image information provided at a common input of the splitter unit via the transmission cable on different image channels.

2. The device as claimed in claim 1, wherein the interconnection unit connects an image channel of each input to one of the different image channels of the common output.

3. The device as claimed in claim 1, wherein the interconnection unit is operable to route an image channel and a clock channel to the common output for each input.

4. The device as claimed in claim 1, with the connecting cables and the transmission cable include DVI standard cables.

5. The device as claimed in claim 2, wherein an image channel is selected for transmission, the image channel including color information and additional information for display of the images by a display element.

6. The device as claimed in claim 5, wherein the image channel with the blue color information is selected as the image channel.

7. The device as claimed in claim 1, wherein the connecting cables and the transmission cable include plug-in connectors attached to both ends of each the connecting cables.

8. The device as claimed in claim 1, wherein the interconnection unit includes a memory unit for each connecting cable, the memory unit being operable to store information relating to the characteristics of the corresponding display element.

9. The device as claimed in claim 1, wherein the splitting unit is operable to provide the monochrome image information present at one of the image channels of the common input on each image channel of an output.

10. The device as claimed in claim 1, wherein the transmission cable includes an integrated transmitter and an integrated receiver for the transmission of the image information.

11. The device as claimed in claim 1, wherein the transmission cable includes a fiber optic cable.

12. The device as claimed in claim 1, wherein the transmission cable includes an Ethernet cable.

13. The device as claimed in claim 1, wherein power is supplied to the interconnection unit, the splitting unit, or both via at least one of the connecting cables.

14. The device as claimed in claim 10, wherein power is supplied to the transmitter of the transmission cable, the receiver of the transmission cable, or both via the interconnection unit or the splitting unit.

15. The device as claimed in claim 1, wherein the interconnection unit, splitting unit, or both include one or more status displays that are operable to display an operating status.

16. An adapter system comprising:
an interconnection unit; and
a splitting unit,
wherein the interconnection unit is operable to combine the image information provided at a plurality of inputs on different channels to a common output, and wherein the splitting unit is operable to distribute the image information provided at a common input on different image channels to a plurality of outputs of the splitter.

17. The adapter system as claimed in claim 16, wherein the inputs, the outputs, the common input and the common output are embodied for the connection of standard cables.
